(19) United States
(12) Patent Application Publication
(10) Pub. No.: US 2023/0291725 A1
(43) Pub. Date: Sep. 14, 2023

(54) Computer-Implemented Registration Authority, System and Method for Issuing a Certificate

(71) Applicant: Siemens Aktiengesellschaft, Muenchen (DE)

(72) Inventor: Anna PALMIN, Karlsurhe (DE)

(21) Appl. No.: 18/180,313

(22) Filed: Mar. 8, 2023

(30) Foreign Application Priority Data
Mar. 10, 2022 (EP) 22161420

(51) Int. Cl. H04L 9/40

(52) U.S. Cl. CPC H04L 63/0823; H04L 63/20

(57) ABSTRACT

A method for issuing a certificate with a specific certificate profile to a plant component of an industrial plant by a certification authority of the industrial plant, wherein an automated check is performed to determine whether the specific certificate profile can be used by the plant component, and whether the specific certificate profile in the industrial plant is assignable to the plant component before a certificate application made by the plant component is transmitted to the certification authority, where the certificate application is transmitted to the certification authority which, in the event of a successful check of the certificate application, issues the requested certificate with the specific certificate profile for the plant component if both checks are successful.

### BACKGROUND OF THE INVENTION

### 1. Field of the Invention

The invention relates to a computer-implemented registration service, system and method for issuing a certificate.

### 2. Description of the Related Art

Secure communication protocols, such as Hypertext Transfer Protocol Secure (HTTPS) or Open Platform Communications Unified Architecture (OPC UA), are being increasingly used in industrial plants (more precisely, in both discrete plants and industrial process plants). The use of these protocols requires the use of “digital certificates” in accordance with the X.509 standard.

In addition to secure communication, optimal protection of an industrial plant requires compliance with a secure device configuration in accordance with various security requirements, such as “security by default” and “least functionality”. According to current security concepts, before commissioning, plant components are checked in accordance with the security concept for the plant for originality, provisioned and then configured securely (i.e., in accordance with the aforementioned security concept and the security policies based thereupon) using “manufacturer device certificates” (IDevID Cert. according to Institute of Electrical and Electronics Engineers (IEEE) 802.1AR). Only then may the plant components request the necessary customer-specific certificates (LDevID Cert according to IEEE802.1AR) and then communicate securely with their communication partners using these certificates.

The components of an industrial plant generally communicate with more than one communication partner and use more than one secure communication protocol. For example, an industrial automation system (AS) can generally provide its web-based user interface via HTTPS for user access (where an associated TLS server certificate is used) and at the same time (in the role of the OPC UA server) communicate per OPC UA with the associated OPC UA clients. For this reason, the plant components should generally request a plurality of certificates (LDevID Cert.), wherein, from the point of view of security, it is recommended that a dedicated certificate is requested or used for each purpose.

According to current public key infrastructure (PKI) concepts, the certificates required for communication are requested via a registration authority (RA) that plays the role of an intelligent gateway. For this purpose, intelligent plant components (such as network components or industrial controllers and OS/ES servers and industrial edge components) that support a certificate management protocol such as the certificate management protocol (CMP) in accordance with RFC 4210 or in accordance with the Lightweight CMP profile generate a corresponding certificate application and transmit this application to the registration authority.

Generally, each certificate issued for a specific purpose is not only requested initially during its life cycle, but should/can also be renewed and/or revoked. As a result, the aforementioned CMP protocol offers, for example, various so-called CMP messages that can be used to identify the respective type of certificate application (or the respective underlying use case). For example, if the registration authority receives an initial request (IR) message from a plant component, it identifies that this is an initial (first-time) request for a specific certificate. From a CR or RR message, it identifies an application for the renewal or revocation of an existing certificate.

Even if, from a purely technical viewpoint, all certificate types such as TLS Server, TLS Client, OPC UA Server or OPC UA Client certificates could be issued by the same certification authority (CA), separation and hence the use of a dedicated certification authority for each purpose or each communication protocol (such as TLS or OPC UA) is recommended with regard to security. The reason is that, if a device uses a plurality of different certificates for different purposes or a plurality of communication protocols used by the device that were issued by the same certification authority and this certification authority is compromised, then the device can no longer communicate via a secure communication protocol because its (only) certificate issued and authenticated by a compromised certification authority is hence no longer considered to be trustworthy.

Even in cases in which, according to the aforementioned recommendation, different certification authorities are used to issue certificates for different purposes/communication protocols, the certificate request is generally made via a (central) registration authority (RA). Herein, the registration authority can identify the purpose of the envisaged certificate, for example, from the contents of the certificate application or from the http/https path via which it receives the certificate application.

If a corresponding configuration has been made, then the registration authority can generally forward the different certificate applications to the different competent certification authorities. In this regard, it should be mentioned that, when using the CMP protocols, it is in principle possible for the plant components to specify the certification authority to be addressed in the “recipient” field accordingly. However, this assumes that they “know” various certification authorities and their assignment to the various certificate profiles and this is rarely the case in practice. Normally, the plant components only know the registration authority (or, in the case of segmented networks, the competent local registration authority (LRA)) as the contact for the certificate request.

The registration authority generally checks the certificate applications it receives as follows:
(I) Check to determine whether there is an inventory entry for the applicant that contains specific data contained in the certificate application that identifies the applicant (in particular its ID, in the registration authority's inventory (or a dedicated inventory), i.e., check whether the applicant is known to it. If the result of the check is not OK: certificate application is rejected. If the result of the check is OK, go to step II.
(II) Check to determine whether the certificate application, or more precisely its signature, is correct and valid in accordance with RFC5280 (which roughly means that the signature of the certificate application “matches” the certificate application). If the result of the check is not OK: certificate application is rejected. If the result of the check is OK, go to step (III).
(III) Check to determine whether the certificate used to sign the certificate application was issued by a certification authority (known to the registration authority) with which the registration authority already has a relationship of trust (which can, for example, mean that the associated “certificate chain” is held accordingly in the configuration of the registration authority and/or its “certificate store”). If the result of the check is not OK: certificate application is rejected. If the result of the check is OK, the certificate application is forwarded to the corresponding certification authority (which is, for example, named in the CMP message or specified in the configuration).

EP 3 258 662 A1 discloses a method for registering an intelligent electrical device with a certification authority.

U.S. Pat. No. 5,745,574 A discloses a security infrastructure with a plurality of certification authorities.

EP 3 287 925 A1 discloses a computer apparatus for transmitting a certificate to a device in an installation.

WO 2020/078750 A1 discloses a method for the secure operation of an industrial automation device in an automation system. In this context, a registration authority for receiving and forwarding certificate applications is described.

In the prior art, every certificate application that has successfully passed checks (I) to (III) is forwarded to the corresponding certification authority (configured in the registration authority), which may possibly result in many unnecessary certificates being issued. This in particular results in the following problems:
increased communication volume (which may possibly endanger normal operation and availability of the industrial plant) since, during the initial request, the plant components transmit unnecessary certificate applications to the registration authority, which then forwards them to the competent certification authority, which then transmits superfluous certificates to the applicants via the registration authority and, since all certificates issued (including the superfluous certificates) are renewed shortly before expiration, this in turn leads to unnecessary administrative work/communication volume;
increased storage requirements for the plant components that hold all superfluous certificates in their “certificate store” and the associated cryptographic keys in the associated “key store” (ideally, hardware-bound), where this problem is in particular considered to be particularly serious in the case of constraint devices; and
increased storage requirements in the inventory or in the “certificate repository” of the industrial plant, where, according to the current specifications, all certificates issued in the respective environment are to be retained.

### SUMMARY OF THE INVENTION

It is an object of the invention to provide a method for issuing a certificate for a plant component of an industrial plant that avoids the above-described disadvantages and enables more efficient certificate management for the industrial plant.

This and other objects and advantages are achieved in accordance with the invention by a computer-implemented registration authority, a system and a method for issuing a certificate with a specific certificate profile to a plant component of an industrial plant by a certification authority of the industrial plant where, before a certificate application made by the plant component is transmitted to the certification authority, an automated check is performed to determine whether the specific certificate profile can be used by the plant component, and to determine whether the specific certificate profile in the industrial plant may be assigned to the plant component, wherein, in the event of both checks being successful, the certificate application is transmitted to the certification authority, which in the event of a successful check of the certificate application, issues the requested certificate with the specific certificate profile for the plant component.

A certificate should be understood to mean a digital data record that confirms specific properties (in this case of machines, devices, applications and the like). An authenticity and integrity of the certificate can generally be verified via cryptographic methods. A certificate is issued for the use of a plant component in the industrial plant by a certification authority, which is also referred to as a “issuing CA (certification authority)”. Such an issuing CA is generally always online and, based on incoming certificate applications, issues certificates for various applicants which it signs with its own issuing CA certificate. The trustworthiness of the issuing CA is ensured by the fact that its own issuing CA certificate is signed by the certificate of a trustworthy root certification authority (“root CA”) located in a secure environment. Here, it should be noted that the root CA is offline most of the time and is only activated or switched on (in compliance with extremely strict security precautions) when it is to issue a certificate for an associated issuing CA. The root CA can be located outside the industrial plant.

The industrial plant can be a plant from a process industry, such as a chemical, pharmaceutical, petrochemical plant or a plant from the food and beverages industry. This also includes any plants from production industries, factories in which, for example, cars or goods of any kind are produced. Industrial plants suitable for performing the method in accordance with the invention can also come from the field of power generation. Wind turbines, solar farms or power plants for power generation are also covered by the term industrial plant.

The plant component of the industrial plant can be any device or computer-implemented application that requires authentication by one or more certificates for communication with other components of the industrial plant. Plant components of the industrial plant can, for example, be apparatuses such as pumps, valves, motors, boilers and the like, but also software programs.

In order to obtain a certificate that the plant component requires for interaction with other plant components within the industrial plant, the plant component must submit a certificate application addressed to the certification authority (directly or indirectly via a registration authority that will be explained later). Therefore, in other words, the certificate application is an application from the plant component to the certification authority of the industrial plant to issue a certificate to the plant component.

The certificate has a specific certificate profile. Herein, the certificate profile comprises a type of certificate. A type can, for example, be a TLS (Transport Layer Security) server certificate, a TLS client certificate, an OPC UA (Open Platform Communications Unified Architecture) server certificate or an OPC UA client certificate. According to the assigned certificate type and, if applicable, further additional requirements, the certificate profile can comprise specific certificate attributes according to the ITU-T-standard X.509 and their values. Herein, during validation using this certificate profile, every certificate application that does not contain all the specified attributes and values is rejected. The more attributes and/or values prescribed/specified by the certificate profile, the more stringent and precise the validation.

In the context of the invention, an automated check is performed to determine whether the specific certificate profile can be used by the plant component. This means that a check is performed to determine whether the plant component that wishes to submit the certificate application to the certification authority is technically capable of using the certificate it has requested with the specific certificate profile. This would, for example, not be the case if a plant component that is not actually OPC UA-capable requests an OPC UA server certificate or if a plant component that cannot act as a TLS server requests a TLS server certificate.

In the context of a second checking stage, a check is performed to determine whether the specific certificate profile in the industrial plant may be assigned to the plant component that wishes to submit the certificate application. In other words, after checking the basic ability to use the certificate with the specific certificate profile, a check is also performed to determine whether there is an actual need within the industrial plant to use the certificate with the specific certificate profile in the industrial plant. The second stage of the check would, for example, be unsuccessful if, although the plant component can act as a web server (which is why the first stage of the check would still be successful), this functionality is not desired in the context of the respective runtime environment of the industrial environment. The unsuccessful second stage of the check would render the entire check unsuccessful, which is why the certificate application would not be submitted to the certification authority in this case.

The method in accordance with the invention can successfully prevent the issuance of superfluous certificates in the industrial plant thus enabling a well-founded contribution to optimizing communication and maintaining normal operation and availability of the industrial plant.

The check to determine whether the specific certificate profile can be used by the plant component can be performed by the plant component in an automated manner such that the plant component only submits a certificate application in the event of the check being successful. Therefore, in the event of a certificate with a specific certificate profile not being supported by the plant component, no certificate application is submitted at all (and consequently no certificate is transmitted to the certification authority). In the event of the plant component supporting a plurality of certificate profiles, these can be combined in a device profile to increase clarity and to simplify the management of certificate profiles on the manufacturer side and also in the operational environment and to make it more reliable.

For this purpose, information about which certificate profiles the plant component can use is preferably deposited on the plant component. This information can be deposited by a manufacturer of the plant component, an original equipment manufacturer (OEM) of the plant component or an operator of the plant component in the industrial plant on the plant component.

The information is preferably updated on a regular or event-controlled basis, in particular in the event of a functional expansion of the plant component, where the update can be triggered by an operator/user or occur in an automated manner. Such an event can also, for example, be the replacement of the RSA algorithm used for encryption and/or signature formation contained in the certificate profile by an ECC algorithm or a special country-specific algorithm.

Additionally or alternatively to the (first) stage of the check by the plant component itself, the checks to determine whether the specific certificate profile can be used by the plant component and whether the specific certificate profile in the industrial plant may be assigned to the plant component can be performed by a registration authority of the industrial plant, where the registration authority performs the checks in response to the certificate application addressed to the registration authority by the plant component, and where the registration authority only transmits the certificate application to the certification authority in the event of both checks being successful.

Herein, the information required for the (first) check to determine whether the specific certificate profile can be used by the plant component can be deposited in the registration authority by an operator of the industrial plant. The registration authority can use this information to check the certificate application of the plant component in the context of the first stage of the two-stage check. This check is particularly advisable if the plant component itself cannot check whether the certificate profile of a certificate application to be generated can be used by the plant component. If, for example, in the context of the first stage of the check, the registration authority establishes that a certificate profile (e.g., OPC UA) has been requested that is not supported by the plant component (due to its functional scope or the communication protocols it supports), then the registration authority rejects the certificate application and hence does not forward it to the certification authority.

Provided that the plant component is configured to perform the first stage of the check, the plant component can notify the registration authority that the check to determine whether the specific certificate profile can be used by the plant component has been successfully performed by the plant component itself. In response, the registration authority can refrain from rechecking whether the specific certificate profile can be used by the plant component in order to save resources.

The second stage of the check, i.e., the check to determine whether the specific certificate profile in the industrial plant may be assigned to the plant component can occur based on specifications from an operator. For this purpose, the operator can, for example, use a user interface of the registration authority with suitable input masks. The operator can use “applicant profiles” as templates that are defined in advance by the operator itself or by a third party. Such an applicant profile combines the certificate profiles that may be assigned to a plant component in the industrial plant. The use of the applicant profiles facilitates the configuration of the second check.

Alternatively or additionally, the check to determine whether the specific certificate profile in the industrial plant can be assigned to the plant component can occur based on automation of the industrial plant. The automation typically describes communication relationships between the individual plant components of the industrial plant that have a direct influence on which each certificate type the plant components require. For example, the registration authority can read this automation, more precisely a corresponding file, and use it automatically for the second checking stage. This does not require any intervention by an operator, although such intervention is not ruled out.

Herein, changes to the automation of the industrial plant can be captured by a system based on machine learning, where the system automatically adapts the basis for the check to determine whether the specific certificate profile in the industrial plant may be assigned to the plant component if necessary.

Preferably, the result of the checks to determine whether the specific certificate profile can be used by the plant component and to determine whether the specific certificate profile in the industrial plant may be assigned to the plant component is visually presented to an operator of the industrial plant. The operator can then trigger any follow-up actions in order to respond appropriately to the result.

The result of the checks to determine whether the specific certificate profile can be used by the plant component and to determine whether the specific certificate profile in the industrial plant may be assigned to the plant component can, alternatively or additionally to the visual output, be deposited in an archive of the industrial plant, such as on an archive server configured for this purpose.

In the present context, a control system should be understood to be a computer aided technical system comprising functionalities for depicting, operating and controlling the industrial process plant. The control system can also comprise sensors for ascertaining measured values and various actuators. Moreover, the control system can comprise so-called process-related or production-related components that are used to actuate the actuators or sensors. In addition, the control system can inter alia comprise means for visualizing the industrial process plant and for engineering. The term control system also additionally includes further computing units for more complex regulators and systems for data storage and data processing.

The objects and advantages in accordance with the invention are also achieved by a computer-implemented registration authority or a comparable instance or a corresponding comparable service for a control system of an industrial plant configured to receive from a plant component of the industrial plant a certificate application submitted by the plant component and is configured, before the transmission of the certificate application to a certification authority of the industrial plant, to check in an automated manner via an associated processor whether the specific certificate profile can be used by the plant component and whether the specific certificate profile in the industrial plant may be assigned to the plant component, where the registration authority is configured, in the event of both checks being successful, to transmit the certificate application to the certification authority.

The registration authority can, for example, be implemented on an operator station server of a control system. Herein, an “operator station server” should be understood to be a server that centrally captures data from an operating and observation system and generally alarm and measured value archives of a control system of an industrial plant and makes them available to users. The operator station server generally establishes a communication connection to automation systems of the industrial plant and forwards data used to operate and monitor the individual functional elements of the industrial plant from the industrial plant to so-called operator station clients. The operator station server can have client functions for accessing the data (archives, messages, tags, variables) of other operator station servers. The operator station server can be, but is not restricted to, a SIEMENS SIMATIC PCS 7 Industrial Workstation server.

Herein, the computer-implemented registration authority can be configured to perform the check to determine whether the specific certificate profile in the industrial plant may be assigned to the plant component based on specifications from an operator and/or based on automation of the industrial plant.

The objects and advantages in accordance with the invention are moreover achieved by a system that comprises a computer-implemented registration authority as explained above, a certification authority and at least one plant component, where the system is configured to perform a method in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of the present invention and the manner in which these are achieved will become clear and more plainly comprehensible in conjunction with the following description of the exemplary embodiments as explained in more detail in conjunction with the drawings, in which:

FIG. 1 is a schematic illustration of a system in accordance with the invention; and

FIG. 2 a flowchart of a method in accordance with the invention.

### DETAILED DESCRIPTION OF THE EXEMPLARY EMBODIMENTS

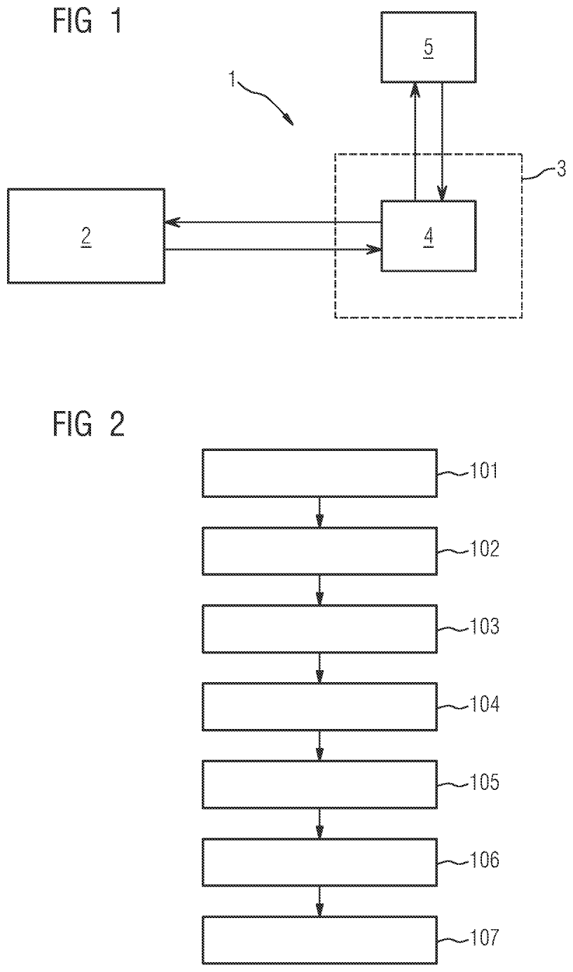

FIG. 1 depicts a system 1 comprising a plant component 2, an operator station server 3 with a registration authority 4 implemented thereon and a certification authority 5. The plant component 2 is connected to the operator station server 3 and the registration authority 4 implemented thereon. Similarly, the certification authority 5 has a connection to the operator station server 3 with the registration authority 4 implemented thereon.

The registration authority 4 is configured in a manner known per se to accept certificate applications from the plant component 2 and forward them to the certification authority 5. In addition, the registration authority 4 is configured to receive certificates issued by the certification authority 5 and forward them to the plant component 2. The certification authority 5 is configured to check certificate applications and, in the event of specific test criteria being met, to issue the requested certificate. In addition, the certification authority 5 can also revoke certificates that have already been issued, but this will not be discussed further in the present context.

FIG. 2 depicts the sequence of the method in accordance with the invention. In a first step 101, the plant component 2 checks whether a certificate application for a certificate with a specific certificate profile, the generation of which was initiated by an operator or in an automated manner by a software component of an industrial plant, may be submitted. Herein, the plant component 2 itself checks via an associated microprocessor as to whether the specific certificate profile that is the subject of the certificate application can be used by the plant component 2. If this is not the case, then the generation of the certificate application is rejected.

In the event of the result of the check being successful, the certificate application is forwarded to the registration authority 4. The data transfer can occur via a field bus, such as an industrial Ethernet.

In a second step 102, the registration authority 4 receives the certificate application and performs a check via an associated microprocessor to determine whether the applicant is known to it. This check occurs in a manner that is known per se by comparing the data of the certificate application (in particular the data relating to the identity of the applicant) with a memory (inventory) assigned to the registration authority 4. In the event of the applicant not being known to the registration authority 4, the certificate application is rejected. In the event of the applicant being known to it, a subsequent third step 103 is performed.

In the context of the third step 103, the registration authority 4 performs a check to determine whether the certificate application, or more precisely its signature, is correct and valid in accordance with RFC5280. In other words, the registration authority 4 checks whether the signature of the certificate application matches the certificate application. In the event of this check not being successful, the certificate application is rejected. In the event of a check being successful, a subsequent fourth step 104 is performed.

In the context of the fourth step 104, the registration authority 4 perform a check to determine whether the certificate used to sign the certificate application was issued by a certification authority (known to the registration authority 4) with which the registration authority 4 already has a relationship of trust. Herein, this can be the certification authority 5 depicted in FIG. 1. The existence of the relationship of trust can, for example, mean that the associated certificate chain is held accordingly in a configuration memory of the registration authority 4 and/or in its “certificate store”. In the event of this check not being successful, the certificate application is rejected. In the event of a check being successful, a subsequent fifth step 105 is performed.

In the context of the fifth step 105, the registration authority 4 performs a check to determine whether the specific certificate profile requested in the certificate application can be used by the plant component 2 (at all). The registration authority 4 can determine which certificate profile is requested from the certificate application, either directly or indirectly, via a source referenced in the certificate application (for example, a URL). In this case, the fifth step 105 is optional, because the plant component 2 has already performed this check itself. However, if this entails a heterogeneous environment/industrial plant in which not every plant component can perform this check verifiably, then it is recommended that this check be performed by the registration authority 4 for all incoming certificate applications. In the event of this check not being successful, the certificate application is rejected. In the event of the check being successful, a subsequent sixth step 106 is performed.

In the context of the sixth step 106, the registration authority 4 performs a check to determine whether the specific certificate profile in the industrial plant can be assigned to the plant component 2. Herein, the registration authority 4 can perform the check based on specifications from an operator or based on automation of the industrial plant which can be kept up to date, in particular by a self-learning system. In the event of this check not being successful, the certificate application is rejected. In the event of the check being successful, a subsequent seventh step 107 is performed.

In the context of the seventh step 107, the certificate application is forwarded to the certification authority 5, where the certification authority 5 performs a check to determine whether the certificate application is valid and, if successful, issues the certificate requested. This is transmitted from the certification authority 5 via the registration authority 4 to the plant component 2, where it is deposited in a certificate memory. The plant component 2 can then, for example, communicate with further plant components of an industrial plant in which the system 1 can be located.

The described invention ensures that in an OT environment/industrial plant only certificates that meet the following requirements are requested from and issued by the corresponding certification authority: (i) the certificate profile is supported by the applicant through its functional scope and/or (ii) the applicant requires this certificate (or its certificate profile) in the context of the respective industrial plant/OT environment.

The issuance of superfluous certificates can substantially be eliminated entirely by the invention thus making a well-founded contribution to the following significant improvements: (i) to the optimization/minimization of the storage space needed to store the certificates in the certificate store of the plant components, (ii) to the optimization/minimization of the storage space needed to store the certificates in the inventory/Repository of the OT environment/industrial plant, (iii) to the optimization/minimization of administrative effort for administering the certificates issued in the OT/environment or in the industrial plant (because experience has shown that even superfluous certificates are currently monitored by the plant components or by other instances for their expiration and renewed accordingly shortly before expiration with the support of the RA/CA), (iv) to the optimization of the communication volume (because unnecessary/superfluous certificate applications are not forwarded to the registration authority or the certification authority and the subsequent issuance of the (superfluous/unnecessary) certificates based on these certificate applications and the transmission of these certificates to the applicants does not take place at all), (v) to the maintenance of normal operation and availability of the OT environment/plant (due to all the aforementioned advantages), (vi) to crypto-agility, because the certificate-specific device and applicant profiles introduced in the present invention have a very high degree of flexibility and configurability which, in particular in cases when a cryptographic algorithm used has been broken or is not allowed to be used (e.g., in a specific country), enables rapid replacement of this algorithm by another suitable algorithm.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for issuing a certificate with a specific certificate profile to a plant component of an industrial plant by a certification authority of the industrial plant, before a certificate application of a certification made by the plant component is transmitted to the certification authority, the method comprising:
performing an automated check to determine whether the specific certificate profile is usable by the plant component; and
performing a check to determine whether may be assigned the specific certificate profile in the industrial plant is assignable to the plant component;
wherein, in an event both checks are successful, the certificate application is transmitted to the certification authority which, in an event of a successful check of the certificate application, issues the requested certificate with the specific certificate profile for the plant component.

2. The method as claimed in claim 1, wherein said check to determine whether the specific certificate profile is useable by the plant component is performed by the plant component in an automated manner such that the plant component only submits a certificate application in the event of the check being successful.

3. The method as claimed in claim 2, wherein the plant component performs the check to determine whether the specific certificate profile useable by the plant component in an automated manner based on information previously deposited on the plant component by one of (i) a manufacturer of the plant component, (ii) an original equipment manufacturer of the plant component and (iii) an operator of the industrial plant.

4. The method as claimed in claim 3, wherein the information previously deposited on the plant component is updated on a regular or event-controlled basis; and wherein the update is triggerable by an operator of the industrial plant or occurs in an automated manner.

5. The method as claimed in claim 4, wherein the information previously deposited on the plant component is updated in an event of a functional expansion of the plant component.

6. The method as claimed in claim 1, wherein said checks to determine whether the specific certificate profile is usable by the plant component and to determine whether the specific certificate profile in the industrial plant is assignable to the plant component are performed by a registration authority of the industrial plant;
wherein the registration authority performs the checks in response to the certificate application addressed to the registration authority by the plant component; and
wherein the registration authority only transmits the certificate application to the certification authority in the event of both checks being successful.

7. The method as claimed in claim 1, wherein said check to determine whether the specific certificate profile is useable by the plant component is performed by the plant component in an automated manner such that the plant component only submits a certificate application in the event of the check being successful;
wherein said checks to determine whether the specific certificate profile is usable by the plant component and to determine whether the specific certificate profile in the industrial plant is assignable to the plant component are performed by a registration authority of the industrial plant;
wherein the registration authority performs the checks in response to the certificate application addressed to the registration authority by the plant component;
wherein the registration authority only transmits the certificate application to the certification authority in the event of both checks being successful; and
wherein the plant component notifies the registration authority that said check to determine whether the specific certificate profile is usable by the plant component has been successfully performed by the plant component itself.

8. The method as claimed in claim 1, wherein said check to determine whether the specific certificate profile in the industrial plant is assignable to the plant component occurs based on specifications from an operator.

9. The method as claimed in claim 1, wherein said check to determine whether the specific certificate profile in the industrial plant is assignable to the plant component occurs based on automation of the industrial plant.

10. The method as claimed in claim 9, wherein changes to the automation of the industrial plant are captured by a system based on machine learning; and
wherein the system automatically adapts a basis for the check to determine whether the specific certificate profile in the industrial plant is assignable to the plant component when necessary.

11. The method as claimed in claim 1, wherein a result of said checks to determine whether the specific certificate profile is usable by the plant component and whether the specific certificate profile in the industrial plant is assignable to the plant component is visually presented to an operator of the industrial plant.

12. The method as claimed in claim 1, wherein a result of said checks to determine whether the specific certificate profile is usable by the plant component and whether the specific certificate profile in the industrial plant is assignable to the plant component is deposited in an archive of the industrial plant.

13. A computer-implemented registration authority for a control system of an industrial plant, comprising:
a processor; and
memory;
wherein the registration authority is configured to receive from a plant component of the industrial plant a certificate application submitted by the plant component, and is configured, before transmission of the certificate application to a certification authority of the industrial plant, to check in an automated manner whether the specific certificate profile usable by the plant component and whether the specific certificate profile in the industrial plant is assignable to the plant component; and
wherein the registration authority is configured, in an event of both checks being successful, to transmit the certificate application to the certification authority.

14. The computer-implemented registration authority as claimed in claim 13, wherein the computer-implemented registration authority is configured to perform the check to determine whether the specific certificate profile in the industrial plant is assignable to the component based on specifications from at least one of (i) an operator and (ii) automation of the industrial plant.

15. A system comprising:
a computer-implemented registration authority including a processor and memory;
a certification authority; and
at least one plant component;
wherein, before a certificate application of a certification made by the plant component is transmitted to the certification authority, the system is configured to:
perform an automated check to determine whether the specific certificate profile is usable by the plant component; and
perform a check to determine whether may be assigned the specific certificate profile in the industrial plant is assignable to the plant component;
wherein, in an event both checks are successful, the certificate application is transmitted to the certification authority which, in an event of a successful check of the certificate application, issues the requested certificate with the specific certificate profile for the plant component.
